(19) United States
(12) Patent Application Publication
(10) Pub. No.: US 2020/0207941 A1
(43) Pub. Date: Jul. 2, 2020

(54) PLASTICS COMPOSITE REINFORCED WITH CARBON FILLER

(71) Applicant: ExxonMobil Research and Engineering Company, Annandale, NJ (US)

(72) Inventors: Arnold Lustiger, Edison, NJ (US); Huaxing Zhou, Warwick, PA (US)

(21) Appl. No.: 16/716,601

(22) Filed: Dec. 17, 2019

Related U.S. Application Data
(60) Provisional application No. 62/785,750, filed on Dec. 28, 2018.

(51) Int. Cl. C08K 3/04; C08J 3/12; C08J 3/205

(52) U.S. Cl. CPC C08K 3/041; C08K 3/042; B82Y 30/00; C08J 3/2053; C08J 3/12

(57) ABSTRACT

Plastics composites and a method for forming the plastics composites are provided in this disclosure. An example plastic composite includes a suspension of carbon nanotubes (CNTs) in a solvent that is compounded with a plastic material. The techniques provide for the efficient incorporation of carbon nanotubes into the plastic composite.

### CROSS-REFERENCE TO RELATED APPLICATIONS

This application claims the benefit of U.S. Provisional Application No. 62/785,750 filed on Dec. 28, 2018, the entire contents of which are incorporated herein by reference.

### FIELD

The present techniques provide for the reinforcement of plastics by compounding a carbon compound into the plastic. More specifically, the present techniques provide for the efficient incorporation of carbon nanotubes into the plastic composite.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Adding carbon allotropes, such as carbon black, as fillers to plastics is used to add conductivity, add color, increase abrasion resistance, and the like. Other carbon allotropes, such as single-walled carbon nanotubes (CNTs) appear to have substantial potential for plastics reinforcement. However, dispersing the CNTs may be problematic, as the CNTs form agglomerates that may not mix well into the plastic.

Various grafting approaches have been tested to increase compatibility with polymers, potentially dispersing the CNTs. For example, reacting of a surface of the carbon nanotubes with various polymers that are miscible in the polymer that is being reinforced.

In one example, a six-step process was used to graft poly-n-butyl methacrylate to the nanotubes. The methacrylate is an acrylic polymer that is miscible with polyvinylchloride. The study showed an increase in glass transition temperature and an approximate doubling of yield point and toughness with as little of 0.5% volume percent of nanotubes. See Jia-Hua Shi, et. al., Nanotechnology 18, 375704 (2007).

In another example, carbon nanotubes were dispersed in tetrahydrofuran and reacted with butyl-lithium on its surface. When these polymers were mixed with chlorinated polypropylene, an ionic bond was formed between the polymer and the functionalized nanotubes, resulting again in a doubling of yield point and an improvement in toughness by a factor of three at 0.6 volume percent of nanotubes. See R. Blake et. al., J. Am. Chem. Soc. 126, 10226-10227 (2004).

Although there are many hundreds of papers and publications describing nanocomposites, results like these which illustrate the huge potential of carbon nanotubes in polymers are relatively rare. The success of these approaches depends on the ability to first disperse the nanotubes, functionalize the nanotubes and match the chemistry of the nanotube surface to a polymer system in which either the polymer is miscible or reacts with the functional groups in the nanotubes.

### SUMMARY

An embodiment described in examples herein provides a plastics composite. The plastics composite includes a suspension of carbon nanotubes (CNTs) in a solvent that is compounded with a plastic material.

Another embodiment described in examples herein provides a method for forming a plastics composite. The method includes forming a suspension of carbon nanotubes (CNTs) in a solvent, and compounding the suspension with the plastic material to form the plastics composite.

Another embodiment described in examples herein provides a product formed from a plastics composite. The plastics composite includes a suspension of carbon nanotubes (CNTs) in a solvent that is compounded with a plastic material.

### DESCRIPTION OF THE DRAWINGS

The advantages of the present techniques are better understood by referring to the following detailed description and the attached drawings, in which:

FIG. 1 is a schematic diagram of a procedure for forming a suspension of carbon nanotubes, in accordance with examples;

FIG. 2 is a schematic diagram of a procedure for forming a plastic composite that includes carbon nanotubes, in accordance with examples;

FIG. 3 is a process flow diagram of a method forming a plastic composite including carbon nanotubes, in accordance with examples;

FIG. 4 is a schematic diagram of a procedure for forming plastic composite that includes single wall carbon nanotubes, in accordance with an example;

FIG. 5 is a drawing of a sonication system for forming a suspension of carbon nanotubes, in accordance with examples;

FIGS. 6(A)-(C) are electron micrographs of a dispersion of CNTs formed by sonication of carbon nanotubes in a naphtha solvent, in accordance with examples;

FIGS. 7(A)-(C) are drawings of a mixing procedure of a CNT suspension with a PVC polymer using DAC, in accordance with examples;

FIG. 8 is a drawing of a test specimen for testing the physical properties of plastic composites, in accordance with examples;

FIG. 9 is a plot of stress versus strain for plastic composites at varying concentrations of carbon nanotubes, in accordance with examples;

FIG. 10 is a plot of maximum load (in foot-pounds) versus concentration of CNTs, in accordance with examples; and

FIGS. 11(A) to (C) show a plot of load versus tensile strain for a control sample versus plastic composites at various scales, in accordance with examples.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the examples. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

The present techniques provide for the efficient dispersal of carbon nanotubes (CNTs) in a plastic to form a composite. In previous studies, the CNTs were suspended in a liquid to break up agglomerates. However, it proved problematic to remove the liquid from the CNTs before blending it into the polymer, as the CNTs reformed agglomerates. In the previous examples described herein, CNTs were chemically functionalized while suspended in the liquid, preventing the reformation of agglomerates.

In the present techniques, the liquid suspension of CNTs is directly compounded into the polymer, precluding re-agglomeration without the need for functionalization chemistry. This is performed by suspending the nanotubes in a solvent, such a naphtha. The solvent may be chosen to be compatible with both the nanotubes and the plastic. For example, the use of naphtha provides a suspension that is stable for several weeks. Further, naphtha is a plasticizer for polyvinylchloride (PVC), providing miscibility, which further assist in the dispersion of CNTs in the plastic. Plasticizers are molecularly dispersed in polymers, and if nanotubes are in turn well dispersed in the plasticizer, then blends of plasticizer with polymer should result in well dispersed nanotubes in the PVC.

The suspension may then be blended or compounded with the plastic to form the composite. The final composite may include about 0.1 weight % of CNTs, about 0.24 weight % of CNTs, about 0.5 weight % of CNTs, or about 1.0 weight % of CNTs, depending on the properties desired. Lower amounts of CNTs may provide an increase in strength and stiffness, while retaining ductility. Higher amounts of CNTs may increase the strength and stiffness further, but cause increasing brittleness, as described herein. During compounding, excess solvent may be removed, for example, by using a twin-screw compounding/devolatilizing extruder, which passes the melt through vacuum domes to remove solvent. Alternatively, much if not most of the volatile plasticizer can be removed from the blend by placing the pellet samples in a vacuum oven at moderate temperature overnight or over a number of days. Other techniques may be used for the blending, depending on the scale of material to be produced, such as dual asymmetric centrifugation, among others.

After compounding, the plastic composite may be pelletized for further processing. The approach is not limited to PVC. Any polymer that can be plasticized or mixed with the liquid will function the same way. The suspension will allow the CNTs to remain dispersed after the agglomerates are broken up, and the suspension may be added to the polymer during a compounding procedure.

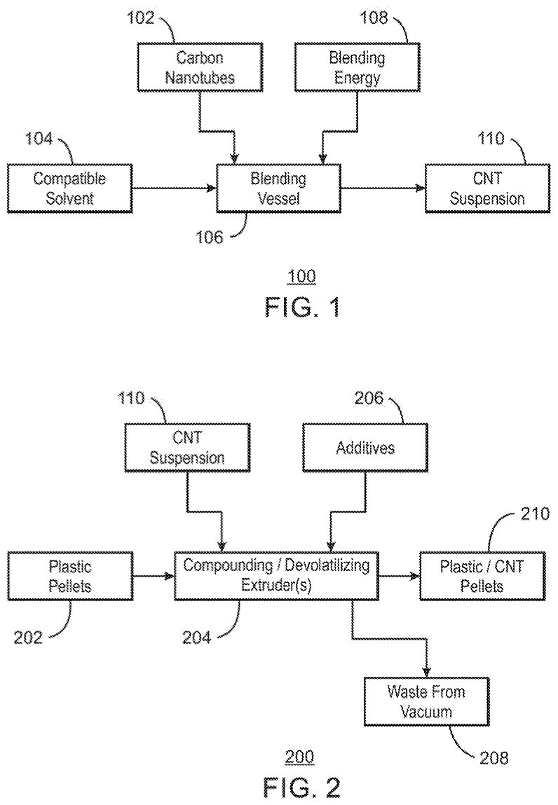

FIG. 1 is a schematic diagram of a procedure 100 for forming a suspension of carbon nanotubes, in accordance with examples. In the procedure, the carbon nanotubes 102 are combined with the compatible solvent 104 in a blending vessel 106. As used herein, carbon nanotubes can be single walled carbon nanotubes, double walled carbon nanotubes, multiwalled carbon nanotubes, or any combinations thereof. Further, other types of graphene-based compounds may be used instead of, or in addition to, the carbon nanotubes. Accordingly, the use of the term carbon nanotubes herein, and in the claims, includes all of these materials.

As used herein, compatible solvents include any solvent that can suspend CNTs for a sufficient period of time to allow the suspension to be compounded with a plastic, such as about 5 minutes, about 30 min., about 1 hour, about 24 hours, or about 168 hours, or longer. The compatible solvent 104 may be selected based, at least in part, on the amount of time available between blending and use. In some examples, the compatible solvent is a naphtha solvent, such as Aromatic 200, available from the Exxon Mobil corporation. As used herein, a naphtha solvent is a distillate stream from a refinery that may include any number of aromatic and nonaromatic compounds, such as toluene, xylenes, ethylbenzene, and short and long chain paraffinic compounds, among others. After blending into a naphtha solvent, the suspension of the CNTs may be stable for several weeks, such as six weeks or more. This may be due to the presence of aromatic rings in the solvent which interact with the aromatic rings in the graphene structures of the CNTs through pi-pi interactions.

Other solvents and materials from oil refining may be used as the compatible solvent 104. These may include, for example, steam cracker tar, steam cracker gas oil, resid, main column bottoms (MCB), and other materials from refinery streams that may contain aromatic rings that interact with the graphene structures.

Further, the compatibility of the compatible solvent 104 with the plastic may influence the selection. For example, the naphtha solvent is a plasticizer for polyvinylchloride (PVC). For example, a normal glass transition for PVC is about 80 to about 85° C., while a 50-50 blend of PVC with a naphtha solvent has a glass transition temperature of around 16° C., and a 67-33 blend of PVC with a naphtha solvent has a glass transition temperature of around 20° C. Accordingly, the naphtha solvent both suspends CNTs effectively, and blends with PVC to form compatible blends.

In other examples, the compatible solvent includes toluene, xylenes, isomers of hexane, isomers of heptane, isomers of octane, or higher paraffinic solvents, among others. In these examples, the suspension may be created in the blending vessel 106, then promptly used in a compounding operation, for example, as described with respect to FIG. 2.

The blending vessel 106 may be any type of vessels that allows the introduction of blending energy 108, for example, while controlling the temperature. In some examples, the blending vessel 106 includes a temperature control system, such as a water bath, to keep the temperature in a range of about 25° C. to about 75° C. during the introduction of the blending energy 108. The blending energy 108 may be introduced through a sonication system that adds ultrasonic energy to the mixture to break up CNT agglomerates. In some examples, one way the blending energy is introduced through a centrifugation system. Other types of high-energy systems may be used to break up the CNT agglomerates, such as high-speed mixing elements.

Once the CNT suspension 110 is formed through the dispersion of the CNTs 102 in the compatible solvent 104, the CNT suspension 110 may be used to form a plastic composite as described further with respect to FIG. 2.

FIG. 2 is a schematic diagram of a procedure 200 for forming a plastic composite that includes carbon nanotubes, in accordance with examples. In this example, plastic pellets 202 are used as the raw material, and may include additives, such as stabilizers, prior to compounding. As used herein, plastic pellets 202 may include powders, fluff, particles, spheres, or other physical polymer forms in addition to pellets. The plastic pellets 202 may include polyvinyl chloride (PVC), high-impact polystyrene (HIPS), styrene butadiene copolymers (SBCs), polyethylene (PE), polypropylene (PP), polyethylene terephthalate (PET), polycarbonate (PC), epoxy, or polyacrylate (PA), among many other kinds of plastics. The plastic pellets 202 may be melted in a compounding/devolatilizing extruder 204, prior to the CNT suspension 110 being added to the melt. Other additives 206, such as stabilizers, colorants, or plasticizers, among others, may also be added to the compounding/devolatilizing extruder 204. Excess amounts of the compatible solvent 104 may be removed, for example, through vacuum domes in the compounding/devolatilizing extruder 204. The waste from the vacuum 208 may be discarded, for example, after condensation and cooling. In some examples, the compatible solvent 104 may be recovered from the waste from the vacuum 208, and reused in the procedure 100 of FIG. 1.

The compounded plastic composite may then be formed into plastic/CNT pellets 210. The plastic/CNT pellets 210 may then be provided to further processes for forming final products.

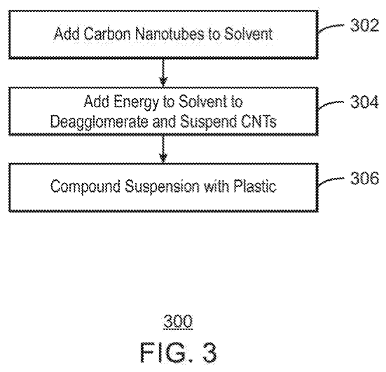

FIG. 3 is a process flow diagram of a method 300 forming a plastic composite including carbon nanotubes, in accordance with examples. The method 300 begins at block 302, with the addition of carbon nanotubes to the solvent. At block 304 energy as added to the solvent to deagglomerate and suspend the CNTs. As described herein, the energy may be added through any number of different techniques, such as sonication, centrifugation, or other techniques. At block 306, the CNT suspension is compounded with the base plastic to form the plastic composite.

### Examples

### Stability of CNT Suspension

To test the stability of the CNT suspension, 0.1% by weight of carbon nanotubes was mixed into 100 mL of a naphtha solvent, Aromatic 200, available from Exxon Mobil. The CNTs were dispersed using sonication, at an ultrasonic power of 50 W for three hours. The suspension of the CNTs in the naphtha solvent was stable for over 6 weeks after initial sonication. In contrast, when CNTs are sonicated into water, the CNTs are initially dispersed, as evidenced by the solution turning black, but after one day the nanotubes settle to the bottom of the container and the liquid becomes clear.

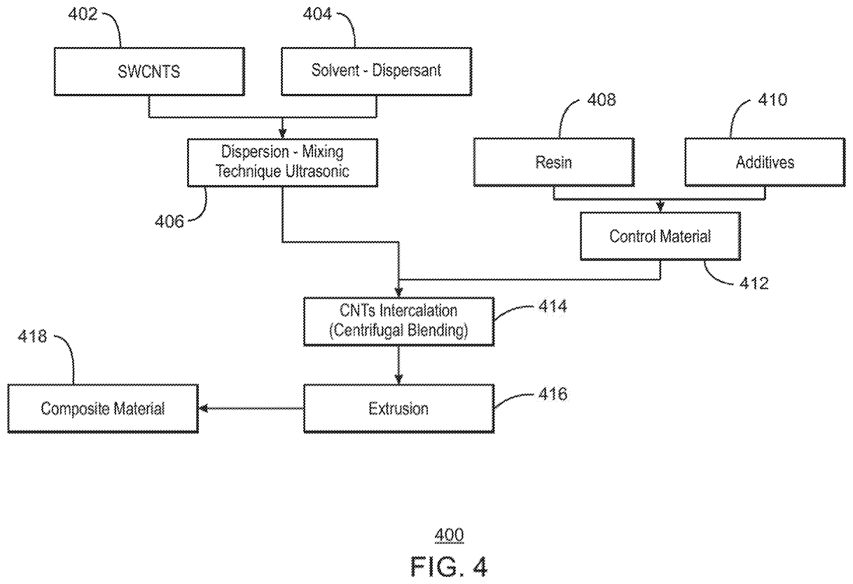

FIG. 4 is a schematic diagram of a procedure 400 for forming plastic composite that includes single wall carbon nanotubes, in accordance with an example. In the procedure 400 used in the example, single wall carbon nanotubes 402 are blended in with a solvent 404 using an ultrasonic dispersion technique 406 to form a suspension of CNTs. In the example of FIG. 4, the single wall CNTs have a surface area greater than about 400 m²/gram.

A base resin 408 is combined with additives 410, such as lubricants, plasticizers, thermal stabilizers, and the like, to form a control material 412. The suspension of CNTs is intercalated 414 with the control material 412 to form a raw mixture, for example, using a dual asymmetric centrifugation (DAC). As used herein, intercalated includes any form of mixing that can disperse the suspension into the control material 412. The DAC may be performed using dual asymmetric centrifuges available from FlackTek, Inc., among others.

The raw mixture is extruded 416, for example, using a small pelletizing extruder. These include units available from Battenfield-Cincinatti Austria GMBH of Vienna, Austria, and Davis Standard of Pawcatuck, Conn., USA. After pelletizing, the composite material 418 is tested, for example, through mechanical property tests, electrical property tests, differential scanning calorimetry, and the like.

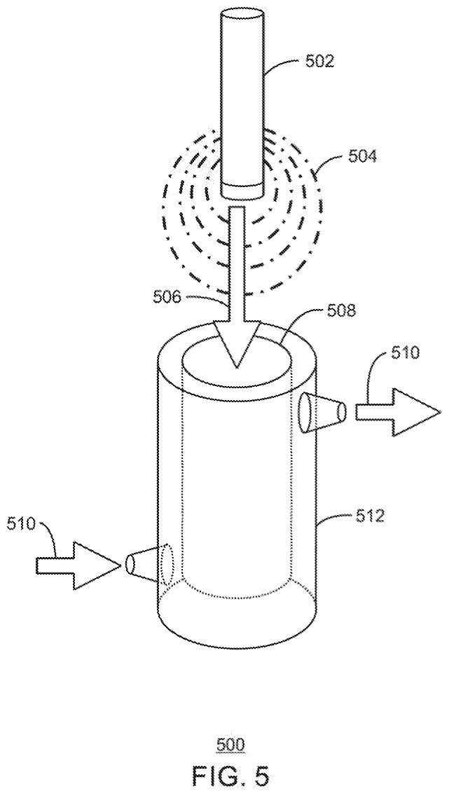

FIG. 5 is a drawing of a sonication system 500 for forming a suspension of carbon nanotubes, in accordance with examples. The sonication system 500 includes an ultrasonic finger 502 that emits ultrasonic sound 504. The ultrasonic finger 502 is inserted 506 into a container 508 that holds the solvent and the CNTs. During the sonication cooling water 510 may be flowed through a cooling jacket 512 to control the temperature in the container 508. In some examples, the cooling jacket 512 is replaced with an ice bath.

The total dispersion weight was 50 g in this example, with the sonication power setting of 7.5. The sonication time was 20 minutes with alternating on and off cycles of 20 seconds. In this example, an ice bath was used for cooling the solution. The sonication power setting of 7.5 gave a power input of about 33.5±3.8 W of power.

To test the power introduced into the solution by the sonication three test runs were run for different periods of time and the power was calculated from the rise in temperature. The sonicated or used for the dispersion has a fixed frequency of 20 kHz and a ½ inch titanium tip. The sonicated tip was submerged and 40 g of the naphtha solvent (AR 200). The initial temperature of the solvent was measured, and then the measured temperature was recorded at 10 second intervals. The resulting power introduced into the solvent was calculated using the following formula:

$$P ( Watts ) = w \times {c}_{p} \times \frac{( {T}_{t} - {T}_{0} )}{t}$$

In this formula, cₚ and w are the heat capacity and weight of the solvent, respectively. In this example, the solvent is Aromatic 200, which has a heat capacity of 224.39 J/mol·K. The results of the tests are shown in Table 1.

TABLE 1
Sonication Power Calculations

| Time (s) | Temperature (° C.) | Power (watts) |
|---|---|---|
| 0 | 22.3 | |
| 10 | 27.6 | 33.5 |
| 20 | 33.8 | 39.1 |

| | |
|---|---|
| Average ± standard deviation | 35.1 ± 3.5 |

Different loadings of CNTs in the solvent were tested, including about 0.10 weight %, about 0.14 weight %, about 0.17 weight %, and about 1.0 weight %. The testing indicated that the sonication was limited to a solid load of less than about 1 weight % of the CNTs in the solvent. Higher solid loads require the use of other mixing techniques, such as dual asymmetric centrifugation.

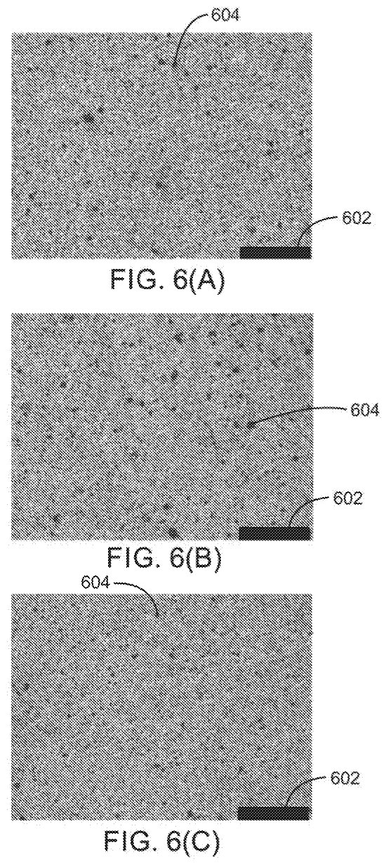

FIGS. 6(A)-(C) are optical micrographs of a dispersion of CNTs formed by sonication of carbon nanotubes in a naphtha solvent, in accordance with examples. The optical micrographs were taken at the same resolution, e.g., 100 μm for the scaling bar in 602 the lower right-hand corner of each figure. FIG. 6(A) was after sonication for 20 minutes, FIG. 6(B) was after sonication for 30 minutes, and FIG. 6(C) was after sonication for 60 minutes. The results of the testing are shown in Table 2. As shown in the optical micrographs, and for the value of X in Table 2, the average size of CNT agglomerates 604 actually increased from 20 minutes of sonication to 30 minutes of sonication, before dropping at 60 minutes of sonication. The G/D ratio in Raman spectroscopy measures the ratio of ordered versus disordered carbon in the nanotubes themselves. The G/D ratio of the nanotubes before sonication was measured at 10, while after sonication the reduction in this ratio suggests damage to the nanotubes due to sonication. Similarly, the last column, which is a measure of bulk conductivity Raman spectroscopy of the G/D ratio of the nanotubes dried after sonication suggests that there was some damage to the nanotubes due to the effect of sonication. For the same reason, the bulk conductivity of the nanotube suspension was reduced with longer sonication times, suggesting damage to the nanotubes.

TABLE 2
Testing of the Sonication of CNTs in a Naphtha Solvent

| time (min) | G/D ratio | Bulk (S · cm) |
|---|---|---|
| 20 | 7.69 | 1200 ± 100 |
| 30 | 6.67 | 1030 ± 100 |
| 60 | 6.67 | 965 ± 100 |
| Solvent | N/A | N/A |
| SWCNTs | 10 | |

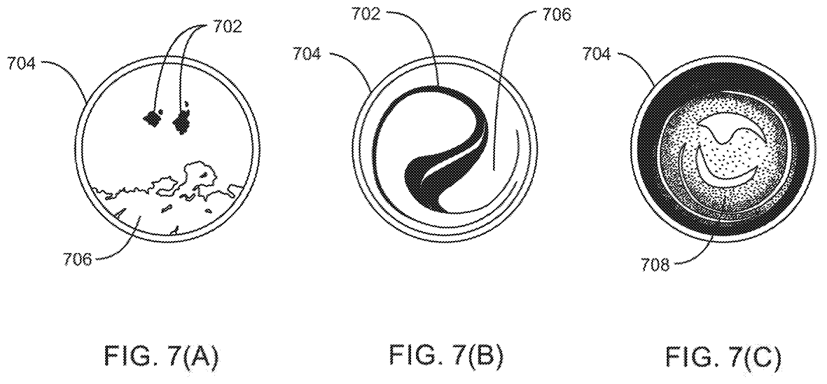

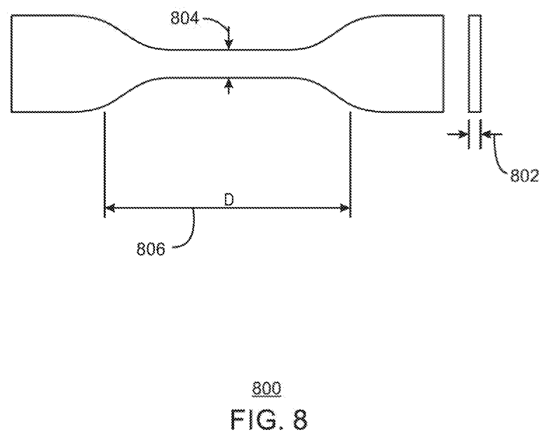

FIGS. 7(A)-(C) are drawings of a mixing procedure of a CNT suspension with a PVC polymer using DAC, in accordance with examples. As discussed with respect to FIG. 4, once a suspension is formed, either by the sonication or by the DAC, the suspension is incorporated into a control material 412 to form the composite material 418. In this example, the mixing was done using a DAC from FlakTek, Speedmixer model DAC 150.1 FVZ. A suspension 702 containing 5 g of single wall carbon nanotubes (SWCNTs) was added to a mixing cup 704 with 11 g of PVC polymer 706. In a first test of mixing at this ratio 1:2.2 of SWCNTs to the PVC polymer, the mixing was performed at 1700 RPM for 30 seconds. In a second test at this ratio, 1800 RPM for 30 seconds was used. In both cases, the efficacy of the mixing was determined by a uniform visual appearance of the mixture.

As shown in FIG. 7(A), prior to mixing the suspension 702 and the PVC polymer 706 are in separate regions. Once the DAC is started, the suspension 702 is distributed into the PVC polymer 706, as shown in FIG. 7(B). Once mixing is completed, as shown in FIG. 7(C), a uniform distribution 708 of the suspension 702 with the PVC polymer 706 is visually confirmed, for example, by a uniform color.

In this example, the DAC is used to mix the suspension 702 with the PVC polymer prior to extrusion. The mixture is formed at a 1 to 1 ratio of the suspension 702 with the PVC, wherein the mixing is done at 1800 RPM for 30 seconds.

### Testing

Once the composite material 418 is formed, it was extruded. In these examples, the extrusion was performed using a HAAKE™ MiniLab 3 Micro Compounder from ThermoFisher Scientific™ of Waltham, Mass., USA. The extrusion was performed as speed setting of about 40 reciprocal minutes (min⁻¹), a temperature of about 175° C., and a torque of about four N·cm. After extrusion, the composite material 418 is used to form test specimens, for example, of the configuration shown in FIG. 8.

FIG. 8 is a drawing of a test specimen 800 for testing the physical properties of plastic composites, in accordance with examples. The test specimen 800 was formed by pressing the plastic composite into a plaque using a press, then cutting out the test specimen 800 with the mechanical punch. The change in the mechanical properties of the PVC due to the incorporation of the SWCNTs may be measured by strain to failure. Strain to failure, also known as elongation at break, is measured along with other tensile properties, generally using ASTM D 638 for unreinforced and reinforced plastics.

ASTM D 638 is run using a test specimen 800 with a dog bone or dumbbell shaped that has a narrow cross-section 802 and a narrow center portion 804, along with wider ends for clamping in the measurement device. In the current example, the narrow cross-section 802 is 0.05 inches, and the narrow center portion 804 having a width of 0.25 inches. The narrow center portion 804 is uniform in width between the wider ends. The wider ends are clamped by tensile grips, and then an extensometer, or other device, may be used to measure the change in length of the narrow center portion. The distance 806 between the tensile grips was 0.875 inches.

During the test the tensile grips are pulled apart at a constant rate of speed. The speed depends on the specimen shape and can range from about 0.05 in./min. to about 20 in./min. depending on the specimen shape. Once the sample ruptures, the test is ended. Usually, five test specimens are sequentially measured to allow sample averaging. The physical properties obtained from the test include tensile strength, elongation at yield, elongation at break (nominal strain at break, or grips separation), modulus of elasticity, secant modulus, and, using a transverse extensometer, Poisson's ratio. The temperature the test is run at is generally ambient, or about 20° C. (68° F.).

In the present example, test specimens were made at four concentrations of SWCNTs. These were a test specimen 800 at 0%, for a control, and SWCNT containing specimens at 0.1 weight % of CNTs, about 0.24 weight % of CNTs, and about 0.5 weight % of CNTs and tested at 0.5 in./min.

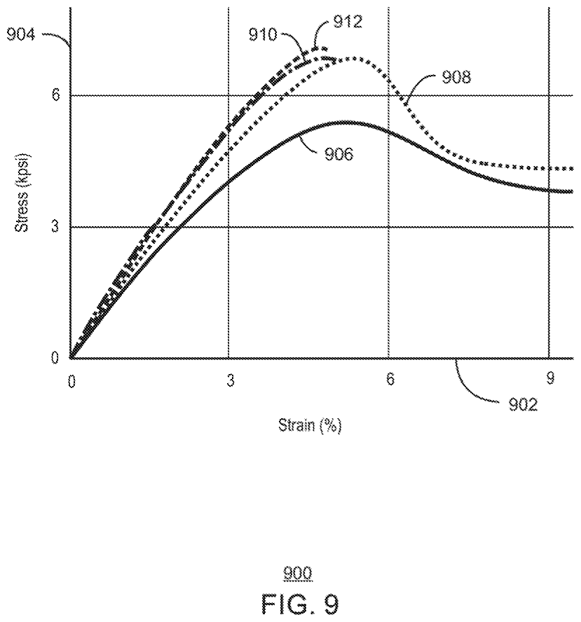

FIG. 9 is a plot 900 of stress versus strain for plastic composites at varying concentrations of carbon nanotubes, in accordance with examples. In the plot 900, the x-axis 902 is strain in percentage of elongation, and the y-axis 904 is stress in thousands of pounds per square inch (Kpsi). An identifier for each of the individual specimens is shown in Table 4. The plot for the control specimen 906 (0 weight % CNTs) gave the Young's modulus of 1196 psi, and showed no failure of the specimen within 9% strain. A plot for a specimen 908 containing 0.1 weight % of CNTs showed an increase in Young's modulus at 1203 psi, but also with no failure of the specimen within the 9% strain. Continuing to increase the content of the CNTs in the specimen increased the stiffness. A stress-strain plot of a specimen 910 containing 0.24 weight % of CNTs showed a further increase in Young's modulus to 1431 psi. This specimen also failed at about 5% elongation. A stress-strain plot of a specimen 912 containing 0.5 weight % of CNTs was similar in properties to the 0.24 weight % sample, having a Young's modulus of 1312 psi and a failure at about 4.8% elongation.

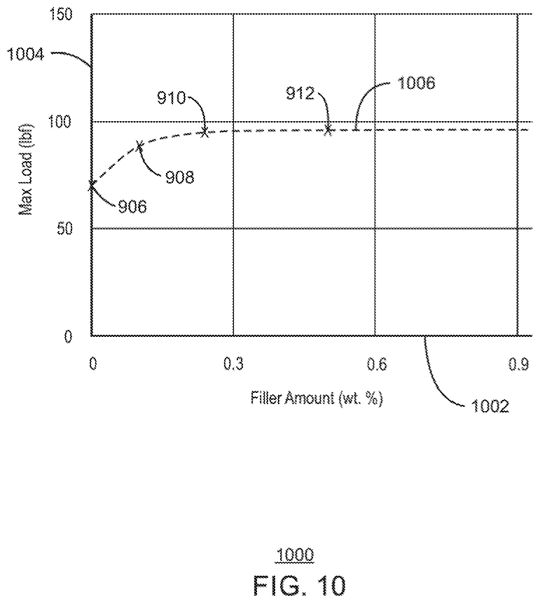

FIG. 10 is a plot 1000 of maximum load (in foot-pounds) versus concentration of CNTs, in accordance with examples. In the plot 1000, the maximum load is shown to flatten out as the CNT concentration increases. The increase in the maximum load is shown in Table 4.

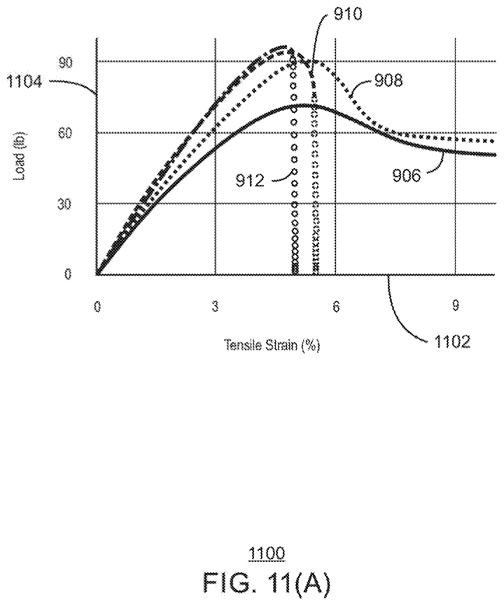

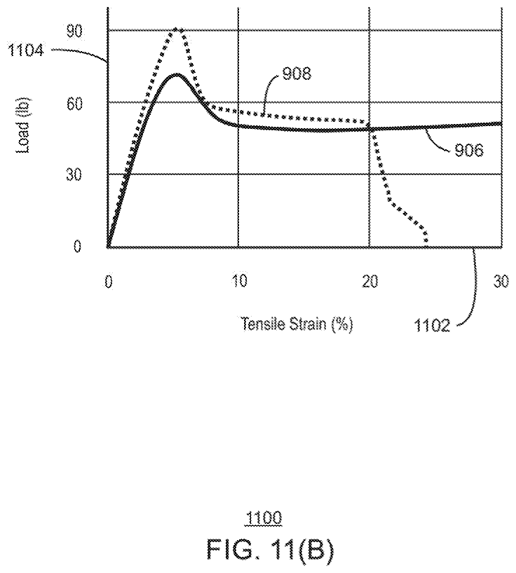

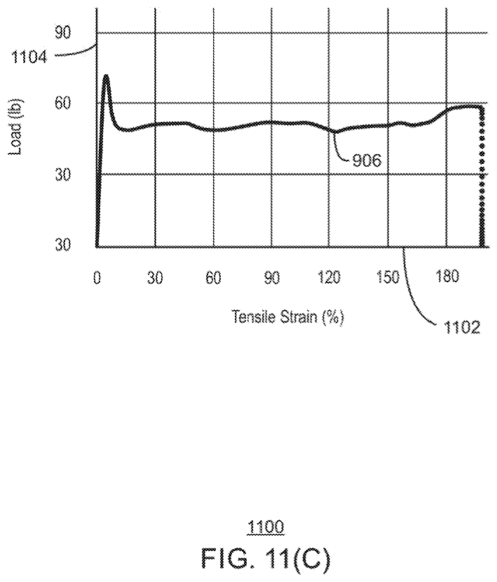

The changes in the properties of the PVC due to the incorporation of the CNTs can be further shown by load (lbs.) versus tensile strain (%) plots over longer range of tensile strain. This is described with respect to FIGS. 11(A) through 11(C).

TABLE 4
Tensile Properties of Composite Materials

| | CNTs | Max load | Tensile stress |
|---|---|---|---|
| Identifier | (weight %) | (pounds) | (Mpa) |
| 906 | 0 | 71 | 32.51 |
| 908 | 0.1 | 89 | 45.68 |
| 910 | 0.24 | 95 | 48.57 |
| 912 | 0.5 | 96 | 48.71 |

FIGS. 11(A) to (C) show a plot 1100 of load versus tensile strain for a control sample versus plastic composites at various scales, in accordance with examples. FIG. 11(A) is a plot 1100 of load (lbs.) versus tensile strain up to a tensile strain of about 10% for a control sample versus plastic composites including various concentrations of CNTs, in accordance with examples. Like numbered items are as described with respect to FIG. 9. As noted herein, higher concentrations of CNTs resulted in both a stiffer material and failure at a shorter elongation percentage.

FIG. 11(B) is the plot 1100 of load versus tensile strain for a control sample versus a plastic composite, in accordance with examples. In this version of the plot 1100, the tensile strain 1102 is carried to 30%. As can be seen in the plot 1100, the plot of the specimen 908 comprising 0.1 weight % of the CNTs shows a higher load than the control specimen 906 before yielding. However, specimen 908 also fails at a lower tensile strain, e.g., about 24% to total failure.

FIG. 11(C) is the plot 1100 of load versus tensile strain for a control specimen 906, in accordance with examples. In this version, the tensile strain 1102 is projected out until failure of the control specimen 906. As can be seen in this plot 1100, the control specimen 906 does not fail until well past 180% tensile strain.

As described herein the tensile test indicated an increase in tensile stress with an increase in the loading of CNTs. At CNT concentrations above 0.25 weight %, the tensile load remained almost constant, while the plastic composite show brittleness. The homogeneity of the distribution of the CNTs may be estimated by variations in Tg value, for example, as measured by differential scanning calorimetry (DSC).

The plastics composite formed using the procedures described herein may be used to form other products. For example, the pellets of the plastics composite may be sold to plastics processing companies to form other products, such as cases for devices, luggage, and the like. In addition to the improved physical properties from the incorporation of the CNTs, the electrical properties may also be improved. For example, the CNTs may improve the static dissipation of the base plastic materials, block radio signals, and the like.

While the present techniques may be susceptible to various modifications and alternative forms, the embodiments discussed above have been shown only by way of example. However, it should again be understood that the techniques are not intended to be limited to the particular embodiments disclosed herein. Indeed, the present techniques include all alternatives, modifications, and equivalents falling within the true spirit and scope of the appended claims.

1. A plastics composite, comprising a suspension of carbon nanotubes (CNTs) in a solvent that is compounded with a plastic material.

2. The plastics composite of claim 1, wherein the carbon nanotubes comprise single wall CNTs, or multiwalled CNTs, or both.

3. The plastics composite of claim 1, wherein the carbon nanotubes comprise graphene-based compounds.

4. The plastics composite of claim 1, wherein the plastic material comprises polyvinyl chloride.

5. The plastics composite of claim 1, wherein the plastic material comprises high-impact polystyrene (HIPS), styrene butadiene copolymers (SBCs), polyethylene (PE), polypropylene (PP), polyethylene terephthalate (PET), polycarbonate (PC), or polyacrylate (PA), or any combinations thereof.

6. The plastics composite of claim 1, wherein the solvent comprises a naphtha solvent.

7. The plastics composite of claim 1, wherein the solvent comprises steam cracker tar, steam cracker gas oil, resid, or main column bottoms (MCB), or any combinations thereof.

8. The plastics composite of claim 1, wherein the solvent comprises paraffinic compounds.

9. The plastics composite of claim 8, wherein the paraffinic compounds comprise isomers of hexane, isomers of heptane, or isomers of octane, or any combinations thereof.

10. The plastics composite of claim 1, comprising about less than about 1 weight % of carbon nanotubes.

11. The plastics composite of claim 1, comprising less than about 0.1 weight % of carbon nanotubes.

12. A method for forming a plastics composite, comprising:
forming a suspension of carbon nanotubes in a solvent; and
compounding the suspension with a plastic material to form the plastics composite.

13. The method of claim 12, wherein forming the suspension comprises:
adding the carbon nanotubes to the solvent to form a mixture; and
adding energy to the mixture to form the suspension.

14. The method of claim 13, wherein adding the energy to the mixture comprises sonicating the mixture.

15. The method of claim 13, wherein adding the energy to the mixture comprises processing the mixture in a dual asymmetric centrifuge.

16. The method of claim 12, wherein compounding the suspension with the plastic material comprises:
blending the suspension with the plastic material to form a raw mixture; and
extruding the raw mixture to form pellets.

17. The method of claim 16, wherein blending the suspension with the plastic material comprises adding the suspension to a melt of the plastic material in a compounding extruder.

18. The method of claim 16, comprising removing excess solvent from the raw mixture.

19. The method of claim 18, comprising passing a melt of the raw mixture through a vacuum dome in a devolatilizing extruder.

20. A product formed from a plastics composite, wherein the plastics composite comprises a suspension of carbon nanotubes (CNTs) in a solvent that is compounded with a plastic material.

21. The product of claim 20, comprising plastic pellets of the plastic composite.

22. The product of claim 20, comprising a case for a device.

23. The product of claim 20, wherein the carbon nanotubes comprise single wall CNTs, or multiwalled CNTs, or both.

24. The product of claim 20, wherein the carbon nanotubes comprise graphene-based compounds.

25. The product of claim 20, wherein the plastic material comprises polyvinyl chloride, high-impact polystyrene (HIPS), styrene butadiene copolymers (SBCs), polyethylene (PE), polypropylene (PP), polyethylene terephthalate (PET), polycarbonate (PC), or polyacrylate (PA), epoxy, or any combinations thereof.
